(19) United States
(12) Patent Application Publication
(10) Pub. No.: US 2020/0380479 A1
(43) Pub. Date: Dec. 3, 2020

(54) MAIL TRANSACTION VERIFICATION SYSTEM

(71) Applicant: Wells Fargo Bank, N.A., San Francisco, CA (US)

(72) Inventors: Kevin R. Cieslak, Novato, CA (US); Jeffrey A. Cornman, San Francisco, CA (US); Chris Kalaboukis, San Jose, CA (US); Darrell L. Suen, San Ramon, CA (US); Christina Zappala Ongpin, Burlingame, CA (US)

(21) Appl. No.: 15/493,626

(22) Filed: Apr. 21, 2017

(51) Int. Cl. G06Q 20/10; G06F 17/27; G06F 17/24; G06K 9/00; G06K 9/18; B07C 3/14

(52) U.S. Cl. CPC G06Q 20/10; G06F 17/2775; B07C 3/14; G06K 9/00469; G06K 9/18; G06F 17/243

(57) ABSTRACT

A mail analysis system includes a mail receiving device structured to receive a piece of mail associated with a user and direct the piece of mail to an imaging area, a scanning device structured to capture a scanned image of the piece of mail in the imaging area, a mail sorting structured to contact the piece of user mail to send the mail in one of a predetermined number of directions, and a processing circuit. The processing circuit is caused to receive the scanned image captured by the scanning device, determine if the piece of mail proposes a transaction to the user, transmit information pertaining to the transaction to a financial institution computing system, receive, an indication of the legitimacy of the proposed transaction from the financial institution computing system, and transmit a control signal to the mail sorting device based on the legitimacy of the proposed transaction.

### TECHNICAL FIELD

The present invention relates generally to the field of digitizing and performing operations on information received by users via paper-based mail.

### BACKGROUND

Although users today commonly engage in internet-based transactions, many users still prefer to engage in certain transactions using paper-based mail. For example, users may pay bills or order products using order forms mailed to them. Unfortunately, many fraudsters attempt to leverage paper-based mail. Users may receive transaction offers from fictitious entities and be unable to identify such entities as fictitious. Additionally, a user may make various errors (e.g., inputting incorrect information into order forms) when engaging in paper-based mail transactions. Accordingly, it would be beneficial to provide assistance to users in engaging in paper-mail based transactions to alleviate these concerns.

### SUMMARY

One embodiment relates to a mail analysis system. The system includes a network interface configured to communicate data over a network. The system also includes a mail receiving device structured to receive a piece of mail associated with a user and direct the piece of mail to an imaging area. The system also includes a scanning device structured to capture a scanned image of the piece of mail in the imaging area. The system also includes a mail sorting device including an engaging portion, the engaging portion structured to contact the piece of user mail to send the mail in one of a predetermined number of directions. The system also includes a processing circuit comprising a processor and a memory, the memory structured to store instructions that are executable by the processor to cause the processing circuit to receive the scanned image captured by the scanning device. The instructions also cause the processor to determine if the piece of mail proposes a transaction to the user. The instructions also cause the processor to transmit, by the network interface, information pertaining to the transaction to a financial institution computing system associated with a financial institution responsive to determining that the piece of mail proposes a transaction to the user. The instructions also cause the processor to receive, by the network interface, an indication of the legitimacy of the proposed transaction from the financial institution computing system. The instructions also cause the processor to transmit a control signal to the mail sorting device based on the legitimacy of the proposed transaction.

Another embodiment relates to a financial institution computing system associated with a financial institution. The system includes a network interface configured to communicate data over a network. The system also includes a customer database configured to store customer information for a customer of the financial institution. The system also includes a transaction database configured to store information pertaining to various paper-mail based transactions engaged in by a plurality of financial institution customers. The system also includes a processing circuit comprising a processor and a memory, the memory structured to store instructions that are executable by the processor to cause the processing circuit to receive, by the network interface, information pertaining to a transaction proposed by a piece of mail received by the customer. The instructions also cause the processor to identify an aspect of the proposed transaction based on the received information. The instructions also cause the processor to determine if the transaction is fraudulent by comparing the identified aspect of the transaction to the aspects of various past fraudulent paper-mail based transactions stored in the transaction database. The instructions also cause the processor to transmit, by the network interface, a fraudulent transaction notification to at least one of a mail analysis device associated with the customer or a customer computing device associated with the customer responsive to determining that the transaction is fraudulent.

Another embodiment relates to a computer-implemented method. The method includes receiving, by a financial institution computing system associated with a financial institution, information pertaining to a transaction proposed by a piece of mail received by a customer of the financial institution. The method also includes identifying, by the financial institution computing system, an aspect of the proposed transaction based on the received information. The method also includes determining, by the financial institution computing system, if the transaction is fraudulent by comparing the aspect of the transaction to the aspects of various past fraudulent paper-mail based transactions stored in a transaction database. The method also includes transmitting, by the financial institution computing system, a fraudulent transaction notification to at least one of a mail analysis device associated with the customer or a customer computing device associated with the customer responsive to determining that the transaction is fraudulent.

### BRIEF DESCRIPTION OF THE DRAWINGS

FIG. 1 is a block diagram of a mail transaction verification system, according to an example embodiment.

FIG. 2 is a flow diagram of a method for assisting a user in management of paper mail, according to an example embodiment

FIG. 3 is a flow diagram of a method for monitoring user paper-based mail transactions for fraudulent activity, according to an example embodiment.

FIG. 4 is a depiction of a user mail interface, according to an example embodiment.

### DETAILED DESCRIPTION

Referring generally to the figures, various systems, methods, and apparatuses related to a mail transaction verification system structured to assist users in conducting paper-mail transactions are described.

According to various example embodiments, as described in further detail below, providing assistance to users engaging in paper-mail based transactions facilitates a financial institution proactively preventing users from engaging in fraudulent transactions. Unlike traditional arrangements, users do not have to personally identify paper-mail based transactions as fraudulent. Instead, using the system described herein, users may conveniently scan received paper-based mail and the paper-based mail is automatically flagged as potentially fraudulent based on various characteristics of the paper-based mail. Beneficially, users may be prevented from engaging in fraudulent transactions using paper-based mail.

In addition, embodiments described herein solve the technical problem of automating various aspects of paper-mail based transactions. For example, using the embodiments described herein, a financial institution computing system becomes aware of various characteristics of a prospective paper-based mail transaction between a user and a third party. The financial institution computing system may perform various fraud checks on the prospective transaction, present graphical depictions of the various characteristics of the prospective transactions to the user or others associated with the user, receive user preferences as they relate to the prospective transaction, and complete the prospective transaction on behalf of the user in accordance with the received preferences. This way, the user can engage in paper-mail based transactions with the assurance that the transactions have been verified by the financial institution and without having to perform the error-prone actions associated with traditional paper-mail based transaction arrangements.

An example implementation may be described as follows. A user receives an offer to engage in a transaction via paper-based mail. The user, or someone associated with the user (e.g., a caretaker), inserts the offer into a scanning device. The scanning device is configured to capture image data of the received offer and perform various operations on the image data. For example, the scanning device may be configured to identify various characteristics of the offer (e.g., the details of the transaction, the sender of the offer, the address of the sender). The scanning device may be further configured to transmit the determined characteristics to a financial institution computing system associated with a financial institution. The financial institution computing system determines if any of the characteristics of the received offer are indicative of the offer being fraudulent. Additionally, the financial institution computing system also transmits a graphical interface viewable by user via the scanning device or a user computing device associated with the user indicating various characteristics of the received offer (e.g., the type of transaction, whether the transaction is fraudulent). The financial institution computing system also receives transaction preferences from the user, and completes a transaction identified by the received offer on behalf of the user in accordance with the received preferences.

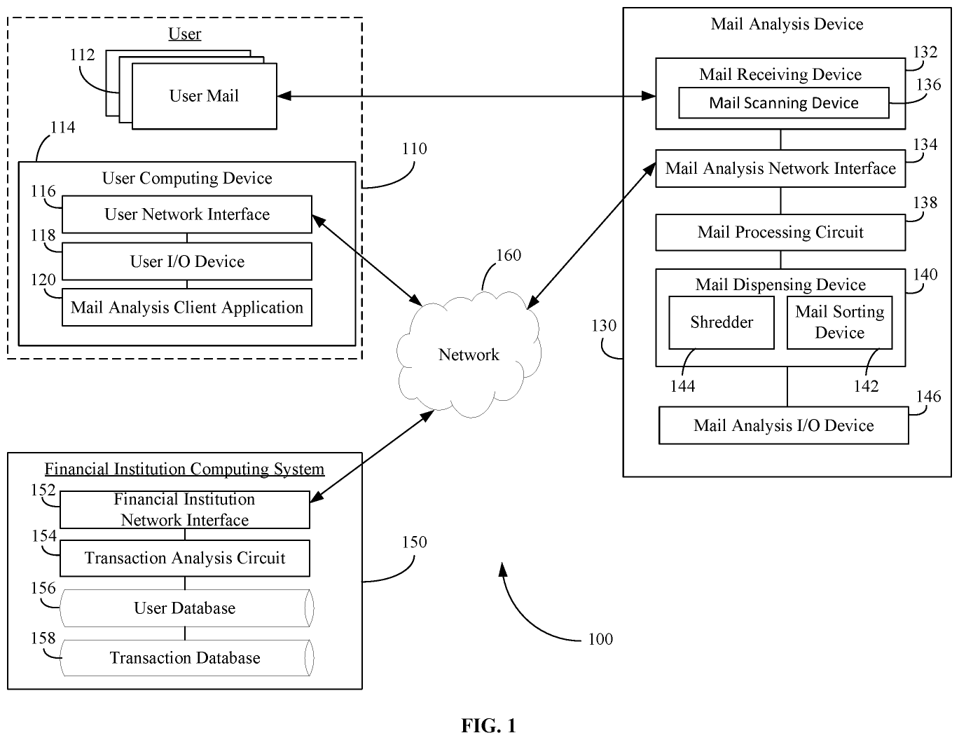

Referring now to FIG. 1, a block diagram of a mail verification system 100 is shown, according to an example embodiment. As will be described in further detail below, the mail verification system 100 both prevents a user 110 from engaging in fraudulent paper-mail based transactions and assists the user 110 in engaging in legitimate paper-mail based transactions. The mail verification system 100 performs various operations on user mail 112. Such operations may include scanning the user mail 112 to create image data of the user mail 112, determining characteristics of the user mail 112, determining if the user mail 112 invites the user 110 to engage in a fraudulent transaction, notifying the user of the fraudulent transaction, automatically shredding the user mail 112 pertaining to the fraudulent transaction, and assisting the user in performing legitimate paper-mail based transactions.

The mail verification system 100 includes a user computing device 114 associated with a user 110, a mail analysis device 130, and a financial institution computing system 150 associated with a financial institution, whereby these components are communicably coupled to each other over a network 160. The network 160 provides communicable and operative coupling between the user computing device 114, the mail analysis device 130, and the financial institution computing system 150, and other components disclosed and described herein to provide and facilitate the exchange of communications (e.g., data, instructions, messages, values, commands, etc.). The network 160 is a data exchange medium, which may include wireless networks (e.g., cellular networks, Bluetooth®, WiFi, Zigbee®, etc.), wired networks (e.g., Ethernet, DSL, cable, fiber-based, etc.), or a combination thereof. In some arrangements, the network 160 includes the Internet. In some embodiments, the network 160 may further include a proprietary banking network to provide secure or substantially secure communications.

The user computing device 114 is a computing device associated with a user 110. The user 110 is any entity capable of receiving paper mail. The user 110 may include both individuals and organizations. In some arrangements, the user 110 is associated with a mailing address to which user mail 112 is directed. In some arrangements, the user 110 is a caretaker, guardian, family member, or the like of a person to which the user mail 112 is addressed. The user mail 112 may include any deliverable physical object such as catalogues, bills, letters, advertisements, newspapers, and the like. In various arrangements, the user 110 or entity associated with the user 110 holds or is otherwise associated with an account at the financial institution associated with the financial institution computing system 150.

The user computing device 114 includes any type of computing device that may be used to communicate information both to and from the financial institution computing system 150. In some arrangements, user 110 uses the user computing device 114 to engage in paper-mail based transactions through communication with the financial institution computing system 150. In this regard, the user computing device 114 may include any wearable or non-wearable device. Wearable devices refer to any type of device that an individual wears including, but not limited to, a watch (e.g., smart watch), glasses (e.g., eye glasses, sunglasses, smart glasses), bracelet (e.g., a smart bracelet), etc. User computing device 114 may also include any type of mobile device including, but not limited to, a phone (e.g., smart phone, etc.), tablet, personal digital assistant, and/or computing devices (e.g., desktop computer, laptop computer, personal digital assistant).

In the example embodiment shown, the user computing device 114 includes a network interface 116 enabling the user computing device 114 to exchange information over the network 160, a mail analysis client application 120, and a user input/output (“I/O”) device 118. The user I/O device 118 includes hardware and associated logics configured to enable the user computing device 114 to exchange information with the user 110, the financial institution computing system 150 and/or mail analysis device 130, as will be described in greater detail below. An input device or component of the user I/O device 118 allows the user to provide information to the user computing device 114, and may include, for example, a mechanical keyboard, a touchscreen, a microphone, a camera, a fingerprint scanner, any user input device engageable with the user computing device 114 via a USB, serial cable, Ethernet cable, and so on. An output device or component of the user I/O device 118 allows the user to receive information from the user computing device 114, and may include, for example, a digital display, a speaker, illuminating icons, LEDs, and so on.

The mail analysis client application 120 is structured to assist the user 110 in paper-mail based transactions. In this regard, the mail analysis client application 120 may be communicably coupled to the financial institution computing system 150 and/or the mail analysis device 130. In some embodiments, the mail analysis client application 120 is a separate software application implemented on the user computing device 114. The mail analysis client application 120 may be downloaded by the user computing device 114 prior to its usage, hard coded into the memory of the user computing device 114, or be a web-based interface application such that the user accesses the mail analysis client application 120 via a web browsing application. In this latter instance, the mail analysis client application may be supported by a separate computing system including one or more servers, processors, network interface circuits, etc., that transmit applications for use to the user computing device 114. In certain embodiments, the mail analysis client application 120 includes an API and/or a software development kit (SDK) that facilitate the integration of other applications (e.g., a mobile banking application or a mobile wallet application).

Irrespective of the form that the mail analysis client application 120 takes, the mail analysis client application 120 is structured to provide displays to the user computing device 114 that assist the user 110 in the management of the user mail 112. In this regard, the mail analysis client application 120 may present the user 110 with displays containing data obtained from the user mail 112 by the mail analysis device 130 through a process described below. Such information may either be received from the financial institution computing system 150 or from the mail analysis device 130 via the network 160. The displays may identify various descriptions of the user mail 112. For example, in one embodiment, the displays include a tabulation of the various communications contained within the user mail 112. The tabulation may include a row for each communication in the received mail and identify each communication's sender, the subject of the mail, and the like. In some arrangements, the displays enable the user 110 to indicate various preferences as to further actions to take with respect to the user mail 112. Actions may include, for example, shredding or sorting the received mail through a process described below. As another example, the displays include a notification to alert the user 110 and/or a guardian/caretaker of the user 110 of potentially fraudulent mail/offers.

In some arrangements, the displays presented by the mail analysis client application 120 may also assist the user 110 in engaging any paper-mail based transaction offers included in the user mail 112. In this regard, through methods described below, the mail analysis client application 120 receives paper-mail based transaction details from the financial institution computing system 150. The transaction details may include digitized aspects of the user mail 112 containing the paper-mail based transaction offers. For example, the displays presented to the user may include digital images of any products or services offered to the user in the received mail, as well as descriptions of product/offer details (e.g., pricing information, shipping information, and the like). The displays may enable the user to indicate preferences with respect to the offer, such as indicating whether the user 110 wishes to purchase a product, or identifying a product to purchase by engaging in a paper-mail based transaction.

In some arrangements, the mail analysis client application 120 is structured to notify the user if any communications contained in the user mail 112 possess any predetermined attributes. For example, through a process to be described in greater detail below, the mail analysis client application 120 receives an indication from the financial institution computing system 150 that a communication contained in the user mail 112 is fraudulent. In such a situation, the mail analysis client application 120 presents a notification screen to the user 110 notifying the user of the fraudulent communication and enabling the user 110 to indicate a preference to shred the piece of fraudulent mail.

In some embodiments, the mail analysis client application 120 is integrated into an existing application provided by the financial institution (e.g., a mobile banking application). As such, the mail analysis client application 120 may also be structured to provide displays to the user computing device 114 that enable the user 110 to manage financial accounts. These displays may be indicative of current account balances, pending transactions, profile information (e.g., contact information), and the like.

The mail analysis device 130 is a device structured to receive and perform various other operations on the user mail 112. In some arrangements, the mail analysis device 130 is a scanning device structured to obtain scanned images of the user mail 112 and includes a processor and associated logics configured to perform various operations described herein, such as transmitting the scanned images to the financial institution computing system 150 over the network 160. In other arrangements, as shown, the mail analysis device 130 includes a scanner as well as other hardware also coupled to the processor and associated logic to perform various other operations on the received mail described in greater detail below. In some embodiments, the user computing device 114 performs a significant portion of the functions performed by the mail analysis device 130. For example, in some embodiments, a camera on the user computing device 114 may perform all of the operations discussed below with respect to the scanning device 136. Additionally, the user computing device 114 may also perform functions described below as being performed by the mail processing circuit 138 such as extracting information from the user mail 112 and sending and receiving information regarding the user mail 112 to and from the financial institution computing system 150.

In the example embodiment shown, the mail analysis device 130 includes a mail receiving device 132, a mail analysis network interface 134 enabling the mail analysis device 130 to exchange data over the network 160, a scanning device 136, mail processing circuit 138, a mail dispensing device 140, and a mail analysis I/O device 146.

The mail analysis I/O device 146 includes hardware and associated logics configured to enable the mail analysis device 130 to exchange information with the user 110 and/or the user computing device 114. In various arrangements, the mail analysis I/O device includes similar structures and performs similar functions to the user I/O device 118 discussed above with respect to the user computing device 114.

The mail receiving device 132 is structured to receive pieces of user mail 112 and image the received mail with a scanning device 136. In some arrangements, the mail receiving device 132 includes a slot opening in which previously opened user mail 112 can be inserted. The slot may be configured such that the user mail 112, upon being inserted into the slot in a predetermined orientation, is in a position to be imaged by the scanning device 136. For example, the user 110 may approach the mail analysis device 130 with a piece of user mail 112 and push the piece of mail in a predetermined orientation (e.g., the content-side of the mail facing in a particular direction with the smaller-dimension side inserted first) to position the mail to be imaged by the scanning device 136. In some arrangements, the mail analysis device 130 includes multiple scanning devices 136 in a plurality of positions configured to capture images of the user mail 112 from a variety of perspectives. In such an arrangement, the particular orientation with which the user mail 112 is inserted into the mail analysis device 130 may not matter.

The scanning device 136 is structured to capture images of user mail 112 inserted into the mail receiving device 132. The scanning device 136 may include any hardware capable of capturing images of user mail 112. In various arrangements, the scanning device includes a charge-coupled device (CCD) array, a light source, and various other hardware components configured to translate light produced by the light source across the user mail so as to produce contrasting signals within each element of CCD array to create a scanned image of the user mail 112. In some arrangements, the scanning device 136 includes a digital video camera or a static image digital video camera. As discussed above, in some arrangements, the mail analysis device 130 includes multiple scanning devices 136 configured to capture various images of both the envelope that contains a communication in the user mail 112 as well as the communication itself.

The mail processing circuit 138 is configured to process images of the user mail 112 captured by the scanning device 136 and transmit various control signals to various other components described herein. In this regard, the mail processing circuit 138 is configured to receive data obtained by the scanning device 136, determine various characteristics of the received user mail 112 based on the received data, communicate the determined characteristics to the financial institution computing system 150 and/or the user computing device 114, receive information from the financial institution computing system 150 and user computing device 114, and perform various operations on the imaged user mail 112 based on the received information and determined characteristics. Accordingly, the mail processing circuit 138 is communicably coupled to the mail analysis network interface 134, the mail dispensing device 140, the user database 156, and the mail analysis I/O device 146.

In some arrangements, the mail processing circuit 138 is configured to determine various characteristics of user mail 112 inserted into the mail receiving device 132 and imaged by the scanning device 136 based on the image data obtained by the scanning device 136. For example, the mail processing circuit 138 may perform an optical character recognition (OCR) process on the data obtained by the scanning device 136 to determine an arrangement of characters on the user mail 112. The mail processing circuit 138 may then assess this arrangement of characters using a plurality of algorithms to determine various characteristics of the user mail 112. The arrangement of characters, for example, may be compared with a plurality of information templates. A first information template, for example, may include various aspects normally included in an address included on a piece of paper mail (e.g., three to four lines of characters being of limited width with sequences of numbers following sequences of letters). Using this information template as a comparative baseline, the mail processing circuit 138 may locate the address on the user mail 112 and determine an identity of the sender of the communication as well as the address of the sender. Other information templates may enable the mail processing circuit 138 to locate other components of the user mail 112 (e.g., the greeting, body, and signature line).

Having determined the various components of the received user mail 112, the mail processing circuit 138 may assess the various components to determine various aspects of the respective components. For example, the mail processing circuit 138 may perform a keyword analysis on the body of the user mail 112 to determine a subject of the received user mail 112. Additionally, the mail processing circuit 138 may perform an analysis to determine if the received user mail 112 proposes a paper-mail based transaction by locating pricing information and various other key words/phrases (e.g., “purchase,” “buy,” “subscribe,” “payment,”). Various aspects of a paper-mail based transaction proposed by the piece of user mail 112 may also be determined through similar procedures (e.g., the identity of any products/services to be purchased, the prices of those products/services, payment instructions such as a return address). In some situations, information regarding the user mail 112 is encoded into a particular data form (e.g., a QR code, barcode, or other postal indicia) located on the user mail 112. Accordingly, the mail processing circuit 138 may decode the information (e.g., regarding the sender of the user mail 112) from these data forms to identify characteristics of the user mail 112 (e.g., a sender address).

Further in this regard, the mail processing circuit 138 may further assess the image data of the received piece of user mail 112 with other image-processing algorithms to determine other characteristics. For example, the mail processing circuit 138 may identify various graphics (e.g., images, icons, logos) on the received piece of user mail 112 and the respective relative locations of the graphics. Once identified, these graphics (and their associated data) may be compared with a set of image data stored in the user database 156 to identify any entities or products associated with those images. For example, if a particular image identified on the received piece of user mail 112 is a logo, the mail processing circuit 138 may compare the logo with various reference logos stored in the user database 156 that are associated with various entities. If a match is found, the mail processing circuit 138 may associate that entity with the received piece of user mail 112 in any communications made pertaining to the piece of mail 112 described below. Similar processes may be performed to with respect to product identity, and the like.

The mail processing circuit 138 may additionally perform several checks to determine if any indications of fraudulent mail are present. For example, in one embodiment, the mail processing circuit 138 compares an address included in the actual communication of the user mail 112 to that included on the envelope that the communication was contained in. If the addresses are different, this may be an indication of a piece of fraudulent mail, so the mail processing circuit 138 may transmit a notification to the user computing device 114. In some embodiments, the mail processing circuit 138 may compare various identified aspects of the user mail 112 to fraud indicators stored in the user database 156. Fraud indicators are attributes of mail previously deemed to be fraudulent. For example, a particular address or sender may be associated with a fraudulent mailing scheme via any of the methods described herein. Accordingly, the mail analysis device 130 may have access to the transaction database 158 at the financial institution computing system 150 described below, and the mail processing circuit 138 may run a comparison of the various aspects of the user mail 112 to other communications previously determined to be fraudulent. To illustrate, a sender of a piece of user mail 112 may be cross-referenced against a sender blacklist identifying various fraudsters. In another example, a color scheme of a piece of user mail 112 may be compared with various other communications previously deemed to be fraudulent by the financial institution.

Alternatively or additionally, a user may input an attribute associated with a previously encountered fraudulent mailing scheme (e.g., via the mail analysis I/O device 147 or the mail analysis client application 120 on the user computing device 114). Additionally, the mail analysis device 130 may receive an updated blacklist of various characteristics (e.g., senders, addresses, language used) of fraudulent mailing schemes over the network 160. For example, the mail analysis device 130 may be configured to automatically receive such updates from a database maintained by a third party. Upon extracting information from the user mail 112, the mail processing circuit 138 may run various comparisons between the user mail and the fraud indicators identified in the blacklist.

Based on the identified characteristics of the user mail 112, the mail processing circuit 138 may be configured to transmit various control signals to various actuating elements (not shown) of the mail analysis device 130. Responsive to these control signals, the actuating elements may relocate the received piece of user mail 112 to the dispensing device 140 described below for sorting and shredding (e.g., so that additional pieces of user mail 112 inserted through the mail receiving device 132 may enter the imaging area of the scanning device 136).

In various arrangements, if the mail processing circuit 138 determines that the received piece of user mail 112 proposes a paper-mail based transaction, the mail processing circuit 138 is configured to communicate information to the financial institution computing system 150. In some arrangements, the mail processing circuit 138 may transmit raw image data to the financial institution computing system 150, which may perform an analysis on the raw image data similar to that discussed above as well as other operations described below to determine the legitimacy of the paper-mail based transaction. In some arrangements, the mail processing circuit 138 is configured to transmit summary of the contents of the user mail 112, including the various characteristics determined above, to the financial institution computing system 150.

After the financial institution computing system 150 performs the various processes described below to determine the legitimacy of any paper-mail based transactions, the financial institution computing system 150 may communicate various determinations to the mail analysis device 130 over the network 160. The mail processing circuit 138 is configured to receive such communications and incorporate the contents into various communications to be transmitted to the user computing device 114. For example, after the scanning device 136 and mail processing circuit 138 have performed the processes discussed above on one or more pieces of user mail 112 inserted into the mail receiving device 132, the mail processing circuit 138 may be configured to generate a report summarizing the contents of the user mail 112. Such a report may contain various determined aspects of the user mail 112. For example, a report may include an entry for each piece of user mail 112 assessed by the mail processing circuit 138 and the financial institution computing system 150 by the processes described herein. Each entry may identify the sender of the piece of user mail 112, the return address (or a portion thereof), a subject, and a date. Additionally, the report may also identify if the user mail 112 proposes a paper-mail based transaction to the user. For such pieces, the entry may further include transaction details (e.g., product/service, price, payment type).

In some arrangements, the report may be transmitted to the user computing device 114 over the network 160. The report may be viewable by the user 110 via the mail analysis client application 120. When viewed via the mail analysis client application 120, the user 110 may be able to indicate various preferences as to the pieces of received mail 112. For example, the user 110 may be able to indicate a preference to shred a particular piece of user mail 112, or to indicate a piece of mail as being “top priority.” For any paper-mail based transactions proposed by the inserted pieces of user mail 112, the user 110 may be able to indicate a preference to engage in the transaction using a particular financial account. Any user interactions with the mail analysis client application 120 may be transmitted to the mail analysis device 130 and/or financial institution computing system 150 over the network 160.

Having received information pertaining to user preferences as to the received user mail 112, the mail processing circuit 138 retrievably stores the user preferences in the user database 156. The user-input preferences (e.g., a sorting/shredding preference, a preference to engage in a proposed transaction) may be transmitted to the financial institution computing system 150 and stored in association with the particular piece of user mail 112 that they pertain to. For example, the user-input preferences may be stored in a data entry associated with a particular piece of user mail 112. In one embodiment, the data entries identify various aspects of the user mail (e.g., sender, address, topic) and include the user preferences. In some embodiments, such stored preferences are used by the mail processing circuit 138 to process mail received at a later date. For example, upon receiving an additional piece of user mail 112, the mail processing circuit 138 may compare characteristics of the additional piece to the information contained in the user mail entries in the user database 156. If a match is found (e.g., the additional piece is from the same sender as that in an entry), the mail processing circuit 138 may retrieve the stored user preference and sort the additional piece in accordance with the stored user preference.

Additionally, the mail processing circuit 138 may further transmit various control signals to the mail dispensing device 140. In various arrangements, the mail dispensing device 140 allows the user 110 to access the user mail 112 that has been processed by the mail analysis device 130. In some arrangements, mail dispensing device 140 includes a slot such as the one discussed above with respect to the mail receiving device 132. As discussed above, the mail analysis device 130 may include various elements configured to relocate the user mail 112 into the mail dispensing device 140 so that it accessible to the user 110.

In some arrangements, the dispensing device 140 includes a mail sorting device 142 and a shredder 144. In various arrangements, the mail dispensing device 140 includes multiple slots or retention points for sorted mail. Each slot may be associated with a particular category of user mail. For example, in one arrangement, the mail dispensing device 140 includes two slots: the first slot may be associated with “high priority” user mail and the second may be associated with “low priority” user mail. Each slot may, for example, be located on an alternative side of the mail analysis device 130. In such arrangements, the sorting device 142 is a mechanical apparatus that can send the received user mail in one of at least two directions: either towards the high priority slot or the low priority slot. Accordingly, the sorting device 142 includes a mechanical switch configured to change the direction that a sorting actuator (not shown) sends the received piece of user mail 112. For example, the sorting actuator may include a set of rollers that engage with the piece of user mail and send it in one of two directions by rotating in either a clockwise or counterclockwise manner. Thus, the mail processing circuit 138 is configured to determine which category that the user mail belongs to (e.g., based on user preference information received or stored in the user database 156, the determined subject of the piece of mail, a date on the user mail), and send a control signal to the sorting actuator that configures the rollers to rotate in a direction that will send the received piece of mail to the corresponding slot. This way, the user 110 is able to quickly view prioritized mail by only viewing pieces of user mail 112 dispensed at the first slot.

In some arrangements, in addition to including various slots associated with various user mail categories, the dispensing device also includes a shredder 144. The shredder 144 includes any device capable of shredding paper or other material commonly sent via paper mail. In some arrangements, the shredder 144 is situated proximate to the imaging area of the scanning device 136. A shredding actuator (not shown) may control a member that engages with the piece of mail 112 that is to be shredded by the shredder 144. The shredding actuator may be separate and distinct from the sorting actuator discussed above. In various arrangements, the shredder 144 may be disposed below the slots of the dispensing device 140 discussed above. Accordingly, while the sorting actuator may send the received user mail 112 in a transverse direction across the imaging area of the scanning device 136, the shredding actuator may send the received user mail 112 below the imaging area of the scanning device 136. In this regard, the mail analysis device 130 may include an additional slot proximate to the imaging area of the scanning device 136 configured to direct the received user mail 112 to a shredding area below the imaging area of the scanning device 136. Upon being inserted into this additional slot, the received user mail 112 may be directed towards a shredder 144 that shreds the mail and distributes the remaining shredded paper into a bin. Thus, the mail processing circuit 138, in response to receiving an instruction to shred a piece of user mail 112 (e.g., either from the user computing device 114 or the financial institution computing system 150), is configured to transmit an activation signal to the shredding actuator such that the piece of user mail 112 is directed to the additional slot into the shredder 144.

Still referring to FIG. 1, the financial institution computing system 150 is a computing system associated with a financial institution. The financial institution may include commercial or private banks, credit unions, investment brokerages, or the like. In various arrangements, the user 110 may have an account (e.g., a checking account, savings account, or the like) at the financial institution. The financial institution computing system 150 includes a financial institution network interface 152 enabling the financial institution computing system 150 to communicate data over the network 160, a transaction analysis circuit 154, a user database 156, and a transaction database 158.

The user database 156 is a storage device structured to retrievably store user information relating to the various operations discussed herein, and may include non-transient data storage mediums (e.g., local disc or flash-based hard drives, local network servers, and the like) or remote data storage facilities (e.g., cloud servers). The user database 156 includes personal user information (e.g., names, addresses, phone numbers, and so on), identification information (e.g., driver's license numbers, standard biometric data, and so on), and user financial information (e.g., token information, account numbers, account balances, available credit, credit history, transaction histories, and so on).

In some arrangements, the user database 156 may include various baseline mail data describing various components commonly found in user mail 112 (e.g., received from the mail analysis device 130). Baseline mail data may include various logos, addresses, images, product descriptions, and the like that may be used by the mail processing circuit 138 to determine the contents of the received user mail 112 as discussed above. User database 156 may also include various preferences set by the user. For example, via the mail analysis client application 120, the user 110 may indicate various preferences as to various aspects of received user mail 112. For example, the user 110 may set a sorting preference for a particular sender or address, such that each piece of received user mail 112 bearing that sender or address is automatically shredded or directed to a high priority slot. Another user preference may include a transaction preference. For example, the user 110 may set a transaction preference associated with a particular sender or product such that each piece of received user mail bearing that sender or product is automatically rejected or the user 110 is never presented with any transaction details on the user computing device 114. In some arrangements, the user database 156 includes historical user mail data describing past received user mail 112. The historical data may include a list of senders, addresses, transactions, and the like included in past user mail 112. In some arrangements, the mail analysis device 130 has access to the user database 156, or includes a database having similar contents to the user database 156 (e.g., excluding user financial information).

The transaction database 158 is a storage device structured to retrievably store information pertaining to paper-mail based transactions of various users, and may include non-transient data storage mediums (e.g., local disc or flash-based hard drives, local network servers, and the like) or remote data storage facilities (e.g., cloud servers). The transaction database 158 may be organized such that various paper-mail based transactions that various users have engaged in are categorized based on their legitimacy. For example, each entry in the transaction database may include information describing various aspects of a transaction such as an address, a product, various logos on the received mail, and arrangement of various components of the transaction offer on the received mail, and the like. Additionally, each entry may be classified as either being fraudulent or non-fraudulent. For example, a particular user in the past may have engaged in a fraudulent paper-mail based transaction and reported it to the financial institution (e.g., via the mail analysis client application 120 on the user computing device 114) such that the entry with respect to that transaction in the transaction database 158 has a fraudulent classification.

The transaction analysis circuit 154 is structured to assist the user 110 in engaging in paper-mail based transactions. In this regard, the transaction analysis circuit 154 is configured to receive data communicated by the mail analysis device 130 regarding received user mail 112, compare the received data with information stored in the transaction database 158, transmit a legitimacy notification back to the mail analysis device 130, and communicate user financial information to entities associated with paper-mail based transactions that the user 110 wishes to engage in. Accordingly, the transaction analysis circuit 154 is communicably coupled to the financial institution network interface 152, the user database 156, and the transaction database 158.

In some arrangements, the transaction analysis circuit 154 is configured to determine if received user mail 112 includes any indicators that the received user mail 112 proposes a fraudulent paper-mail based transaction. In some arrangements, the transaction analysis circuit 154 does this based on information received from the mail analysis device 130. Based on the data received from the mail analysis device 130 (e.g., either the image obtained from the scanning device 136 or a summary report), the transaction analysis circuit 154 is configured to compare the received information to information stored in the transaction database 158. If the characteristics of the received piece of user mail 112 completely match those of a past fraudulent transaction, for example, the transaction analysis circuit 154 may identify the proposed transaction as being fraudulent, and transmit a notification to the mail analysis device 130 and/or user computing device 114 over the network 160.

However, if a match is found only amongst certain aspects of the received user mail 112 and a historical fraudulent transaction, the transaction analysis circuit 154 may perform a more detailed analysis to determine the legitimacy of the offered transaction. For example, if a particular piece of received user mail that proposes a transaction includes a sender that has been associated with a legitimate transaction but an address that has been associated with a fraudulent transaction, the transaction analysis may query the transaction database 158 for all fraudulent transactions associated with that sender and identify the various addresses associated with those transactions. If the address included on the received user mail 112 is not included on any of the past fraudulent transactions, the transaction analysis circuit 154 may identify the transaction as fraudulent, and transmit a notification to the mail analysis device 130 over the network 160.

Alternatively or additionally, the transaction analysis circuit 154 may also perform additional legitimacy tests, such as an analysis of raw image data of the received user mail 112 obtained via the scanning device 136. The transaction analysis circuit 154 may check the location of various elements of the received user mail (e.g., logos, pictures, prices, offerings) against the data stored in the transaction database 158 to determine the legitimacy. For example, the transaction analysis circuit 154 may assess the location of a logo within the received piece of user mail to that of other paper-mail based transactions engaged in by other users to determine the legitimacy of the received piece of user mail 112.

In various arrangements, the transaction analysis circuit 154 is configured to transmit information to various entities on behalf of the user 110 if the user 110 wishes to engage in a paper-mail based transaction proposed by the received user mail 112. For example, as described below, a user may receive details of a proposed paper-mail based transaction and indicate a preference to complete such a transaction using an account held by the user 110 at the financial institution. Responsive to the user 110 indicating such a preference, the user computing device 114 (e.g., via the mail analysis client application 120) may transmit information concerning the proposed transaction to the financial institution computing system 150. Upon receiving this information, the transaction analysis circuit 154 may identify the other party of the transaction and a destination for the user 110's information. For example, in some arrangements, the piece of received user mail 112 may propose paper-mail based transaction and also enable the user 110 to purchase a product/service over the interne and identify a website. Accordingly, the transaction analysis circuit 154 may access the identified website, and automatically input the user's information (e.g., financial account, address) to complete the transaction on behalf of the user. In other situations, where, for example, the received piece of mail does not identify a website, the transaction analysis circuit 154 may pre-populate an order form included in the received user mail 112. Such a form may be printed and mailed by financial institution personnel to a return address identified by the received user mail 112. Thus the user 110 need not even send a reply to the received mail to engage in a transaction proposed to the user 110 over paper mail.

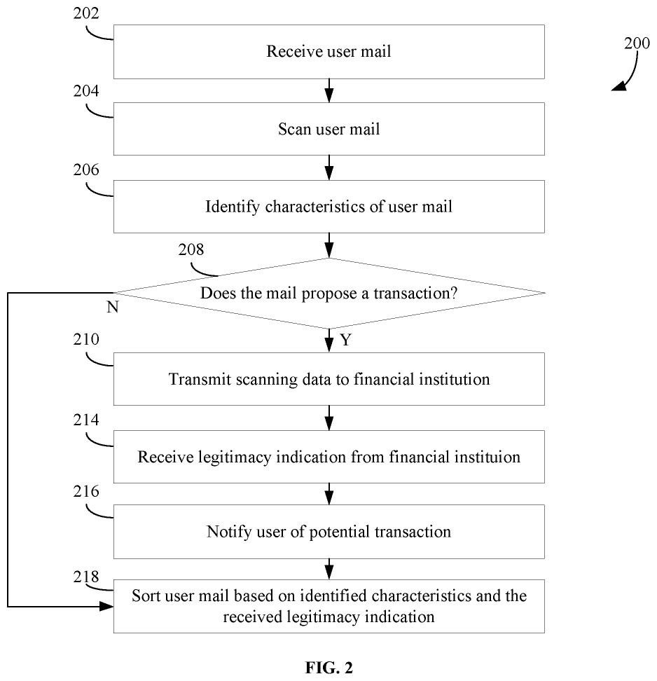

Referring now to FIG. 2, a method 200 of processing a received piece of user mail 112 is shown, according to an example embodiment. In some arrangements, the method 200 is performed using components shown in FIG. 1 such that reference to the components of FIG. 1 aid in the description of the method 200.

A piece of user mail is received at 202. In some embodiments, the user mail 112 is received at the mail receiving device 132. For example, the user 110 may get a piece of mail 112 and insert the piece into the mail receiving device 132 of the mail analysis device 130. In some arrangements, the user 110 may first insert the envelope and then insert the communication contained in the envelope such that the scanning device 136 captures two successive images for the received piece of user mail 112: an image of the envelope and an image of the actual piece of mail 112 itself. In some arrangements, the user mail 112 is inserted into the mail receiving device 132 at the same time it is delivered to the user 110. Accordingly, in some arrangements, the mail receiving device 132 is attached to a mail slot at the user's home and/or work.

An image of the received piece of user mail 112 is captured at 204. In various embodiments, the scanning device 136 captures an image of the piece of user mail 112. In some embodiments, upon the user 110 inserting the piece of mail 212 into the mail receiving device 132, the piece of mail is in an imaging area of the scanning device 136. In some arrangements, imaging commences responsive to a preference received from the user 110. For example, the user 110 may press an “imaging button” or the like included in the mail analysis I/O device 146 to initiate the imaging. In some arrangements, the mail receiving device 132 includes a sensor (not shown) configured to detect the entry of the piece of user mail 112. In such arrangements, upon detection of a piece of user mail 112, the sensing device may transmit a control signal to the scanning device 136 that causes the scanning device 136 to begin imaging. In various embodiments, the scanning device 136 transmits light from a light source onto the piece of received mail 112 which, after interaction with the piece of mail 112 (e.g., either by reflection through the piece of mail 112 or by transmittal through the piece of mail 112) is captured by a sensing device such as a CCD array to create a scanned image.

In some arrangements, the method 200 is initiated at step 204. For example, the method 200 may also be performed in an arrangement where the user 110 captures an image of the received piece of mail 112 using a camera included on the user computing device 114. In such arrangements, the steps 204-216 may be performed by a processor of the user computing device 114 (e.g., as instructed by program logic included in the mail analysis client application 120).

An analysis is performed on the captured image at 206 to identify various characteristics of the received piece of user mail 112. As discussed above, the mail processing circuit 138 may perform an OCR analysis on the captured image to identify an arrangement of characters included on the received piece of user mail 112 and/or the envelope that it was contained in. Based on the arrangement of characters, the mail processing circuit 138 may identify various characteristics of the received piece of user mail 112. For example, an address may be identified based on a specific block or set of lines of symbols. From that address, a return address, a sender, and the like may be identified. Additionally, a topic of the communication may be determined or estimated based on any messages contained in the received piece of mail. For example, the mail processing circuit 138 may identify the most common word contained in the communication.

In addition to the OCR analysis, the mail processing circuit 138 may perform additional analyses on the captured image. For example, the mail processing circuit 138 may include various image recognition algorithms. Through such algorithms, various characteristics of any depictions (e.g., logos, images, and the like) contained on the received piece of user mail 112 may be identified. For example one such algorithm may identify sudden shifts in the gradient and shading in the image captured by the scanning device 136. For example, the space in the received piece of user mail 112 surrounding an image or a logo may be consistently white, while an area including an image or a logo may be consistently a different color. Thus, by the shading of the captured image, the mail processing circuit 138 may identify the dimensions and relative location of the depictions on the captured images. Additionally, the gradient of the image may be measured and thus the gradient associated with each depiction may be determined. Such characteristics may be compared with those of other past communications associated with fraudulent schemes to determine the legitimacy of the user mail 112.

It is determined if the received piece of user mail 112 proposes a paper-mail based transaction to the user 110 at 208. For example, the mail processing circuit 138 may perform a textual analysis on the image captured at 204. For instance, the mail processing circuit 138 may search the OCR-processed image for a specific set of keywords on specific keywords (e.g., “payment,” “buy”, “purchase”, “order”, “shipping”, and the like). Alternatively or additionally, the mail processing circuit 138 may similarly search the received piece of user mail 112 for pricing information or payment amounts (e.g., search for the “$” sign followed by at least one numerical figure). In various arrangements, if the mail processing circuit 138 does not locate any of the keywords discussed above as well as a price or payment amount, then the mail processing circuit 138 identifies the received piece of mail as not proposing a paper-mail based transaction and skips to the step 218 for sorting that will be described below.

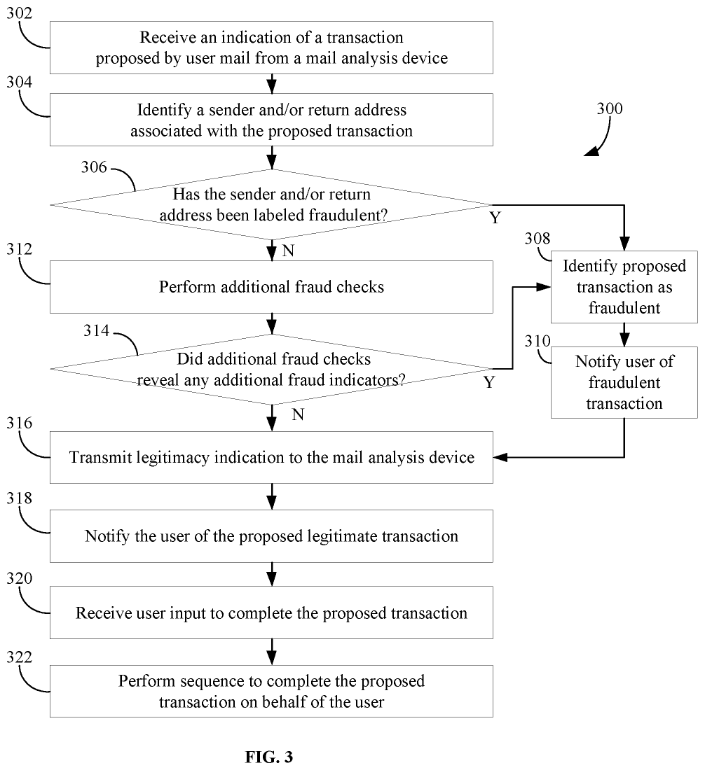

If, however, the received piece of user mail 112 is determined to propose a transaction, information is transmitted to the financial institution computing system 150 at 210. In some embodiments, the mail processing circuit 138 generates a mail transaction notification and transmits the notification to the financial institution computing system 150 over the network 160. In some arrangements, just the scanned image(s) captured by the scanning device 136 is transmitted to the financial institution computing system 150. In some arrangements, both the scanned image as well as a report containing the identified characteristics of the received piece of user mail 112 are transmitted. In some arrangements, only the report is transmitted. Upon receipt of the information from the mail analysis device 130, the financial institution computing system 150 determines the legitimacy of the proposed transaction by the method 300 discussed below in relation to FIG. 3. It should be noted that, in various embodiments, the mail processing circuit 138 may perform any of the steps of method 300 discussed below as being performed by the financial institution computing system 150.

A legitimacy indication of the proposed transaction is received at 212. In some arrangements, the legitimacy indication is received by the mail processing circuit 138 via the network interface 134. By the method described below or any of the methods described herein, the financial institution computing system 150 may determine if the received piece of user mail 112 includes any indications of being fraudulent. If no such indications are found, then the received legitimacy indication may identify the proposed transaction as being legitimate. However, if the received piece of user mail 112 is found to have at least one fraud indicator, the legitimacy indication may identify the transaction as being fraudulent.

The user 110 is notified of the proposed transaction at 214. In various arrangements, the mail processing circuit 138 generates a transaction notification based on the received legitimacy indication for viewing by the user 110. In some embodiments, the notification is presented to the user via a display device included in the mail analysis I/O device 146. Alternatively or additionally, the mail processing circuit 138 may transmit such a notification to the user computing device 114 by way of the network 160 or a local network to which the user computing device 114 and the mail analysis device 130 are both connected. Alternatively, such a notification may be transmitted to the user computing device 114 by the financial institution computing system 150.

In some arrangements, the transaction notification includes a legitimacy indicator that informs the user 110 of the results of the analysis performed by the financial institution computing system 150. As such, the user 110 may be notified if the received piece of user mail 112 proposes a fraudulent transaction. Further, in cases where the transaction is deemed to be legitimate by the financial institution computing system 150, the notification may also identify various aspects of the proposed transaction. For example, the notification may identify a product that the user 110 may purchase by responding to the received piece of user mail 112. Additionally, various other aspects such as a price, sender, and return address may also be identified by the notification. The notification may be formatted such that, upon receipt by the user computing device 114, a specific function of the mail analysis client application 120 is called that brings the user to a paper-mail based transaction interface. Such an interface may be configured to receive an input from the user 110 to complete the proposed transaction. In response to receiving such an input, a signal may be communicated to the financial institution computing system 150 that causes a sequence described below to be initiated in which financial institution completes the proposed transaction on the user's behalf.

In some arrangements, such a transaction notification may be included in a report generated by the mail processing circuit 138. The report may include several entries, with each entry corresponding to a different received piece of user mail 112. For example, the user 110 may receive five pieces of user mail 112 over the course of the day. Accordingly, the processes 202-216 may be repeated for each piece of user mail 112. As the report is generated, the mail processing circuit 138 may transmit the report to the user computing device 114 over the network 160 or via a local network to which both the user computing device 114 and the mail analysis device 130 are connected. The user 110 may view the report via the mail analysis client application 120. Upon viewing the report, the user may indicate various preferences as to the user mail 112. For example, the 110 user may indicate a shredding preference for a particular piece of user mail 112. Upon the user computing device 114 receiving such a preference, a signal may be relayed to the mail processing circuit 138 which may transmit a control signal to the shredding actuator causing that particular piece of user mail 112 to be sent to the shredder 144.

The user mail is sorted at 226. In some embodiments, the mail processing circuit 138 generates control signals for the mail dispensing device 140 based on the characteristics of the user mail 112. In some embodiments, the mail analysis device 130 may include multiple mail dispensing devices 140. In some arrangements, if the legitimacy indication received at 214 identifies that the received piece of user mail 112 proposes a fraudulent transaction, the user mail 112 is sent to the shredder 144.

In some arrangements, other user mail 112 not proposing a transaction or proposing a legitimate transaction may be sorted by being sent to various mail dispensing devices 140. For example, the mail analysis device 130 may include a first mail dispensing device 140 and a second mail dispensing device 140. The first mail dispensing device may be structured to retrievably position the received piece of mail 112 in a first position and a second mail dispensing device 140 may be structured to position the received piece of user mail 112 in a second position. The first and second mail dispensing devices 140 may be arranged such that they are positioned on different sides of the mail analysis device 130. As such, whether the received piece of user mail is sent to the first mail dispensing device or the second mail dispensing device 140 may depend on the characteristics identified at step 206. For example the user database 156 may include a set of user preferences that determines how user mail is sorted. In an example, the user 110 may indicate a preference that only mail received from a select few senders is sent to the first mail dispensing device. Accordingly, the mail processing circuit 138 may compare the sender determined at step 206 with a list of selected senders and, send a control signal to the sorting actuator to direct the piece of user mail 112 to the first dispensing device 140 only if the identified sender belongs to the selected list of senders.

Referring now to FIG. 3, a method 300 of determining the legitimacy of a paper-mail based transaction proposed by a piece of user mail 112 is shown, according to an example embodiment. In various embodiments, the method 300 may be performed by the components of FIG. 1 such that reference may be made to the components of FIG. 1 to aid the description of the method 300.

An indication of a transaction proposed by a piece of user mail 112 is received at 302. In various embodiments, the user 110 may receive a piece of mail 112, insert the piece of mail 112 into the mail analysis device 130, which may scan the piece of mail 112, generate a report describing various aspects of the received piece of mail (e.g., by performing the steps 206-208 discussed above), and transmit such a report to the financial institution computing system 150. In some arrangements, only a scanned image of the received piece of user mail 112 is transmitted to the financial institution computing system 150, where it is received via the network interface 150. In such arrangements, the transaction analysis circuit 154 may perform the analysis discussed above as being performed by the mail processing circuit 138 (e.g., determine the sender of the piece of user mail 112, determine if a transaction is proposed, and the like).

A sender or return address associated with the proposed transaction is identified at 304. In various arrangements, such information may be included in the indication received at 302. Alternatively, transaction analysis circuit 154 may identify the sender or return address from the scanned image received from the mail analysis device 130 at 302. For example, the received piece of user mail 112 may include an address header identifying a return address or the like. Such an address may include both a mailing address as well as the identity of the sender of the piece of user mail. Accordingly, the transaction analysis circuit 154 may perform an OCR analysis or the like on the received scanned image and identify a portion of the image containing the return address.

At 306, it is determined if either the sender or return address have been labeled as fraudulent. In some embodiments, the transaction analysis circuit 154 accesses the transaction database 158 to ascertain whether the sender or return address have been labeled as fraudulent. In various embodiments, the financial institution computing system 150 keeps a record of various schemes through which users have been scammed via paper mail. For example, financial institution personnel may access various data sources (e.g., forums, reporting websites, and the like) and identify various characteristics of fraudulent schemes that leverage paper mail. For example, a list of return addresses associated with various fraudulent schemes may be maintained at the transaction database 158. The financial institution computing system 150 may automatically revisit various data sources to keep such a list up to date. Additionally, customers of the financial institution may report fraudulent transactions that were initiated via paper mail directly to the financial institution computing system 150.

In any event, the transaction analysis circuit 154 may compare the sender and/or return address associated with the proposed transaction to those included on a blacklist or the like maintained at the transaction database 158. If a match is found, then the proposed transaction may be deemed to be fraudulent at 308. In various arrangements, upon identifying the proposed transaction as fraudulent, a notification may be sent to the user at 310. For example, the transaction analysis circuit 154 may package enough information enabling the user 110 to identify the received piece of user mail 112 proposing the fraudulent transaction into a notification message and transmit the notification message to the user computing device 114 by way of a push notification service. For example, the transaction analysis circuit 154 may retrieve a unique user identifier (UID) and package that with the notification message such that the push notification service “pushes” the notification message to the user computing device 114. As such, the user 110 is alerted to any mail received from known fraudulent entities. Further, in addition to transmitting the notification to the user computing device 114, the transaction analysis may also transmit a fraudulent mail indication to the mail analysis device 130 at 316. Upon receipt of such an indication, as discussed above, the mail analysis device 130 may automatically shred the received piece of user mail 112. Thus, the user 110 is prevented from even attempted from engaging in a fraudulent transaction by way of paper mail.

If, however, the sender and/or return address identified by the received piece of user mail 112 is not blacklisted, additional fraud checks are performed at 312. For example, the transaction analysis circuit 154 may retrieve information regarding past (legitimate) paper-mail based transactions performed under the same sender and/or return address. In some arrangements, if there are no past legitimate transactions performed under the sender, a warning notification may be transmitted to the user computing device 114. Such a warning may indicate to the user 110 that the financial institution could not verify that the sender is legitimate. Assuming that there are past transactions under the sender, various comparisons may be made between the received user mail 112 and the past transactions. Various attributes of the proposed transaction (e.g., return address, products offered, payment amounts, etc.) may be compared to those of past transactions. In some arrangements, the transaction analysis circuit 154 may run an image comparison between the image of received user mail 112 and images of past pieces of user mail 112 stored in the transaction database 158 to identify any differences. In some arrangements, the image of the received piece of user mail 112 may be analyzed by financial institution personnel, who may provide an input to the financial institution computing system 150 indicating their opinion as to the legitimacy of the piece of user mail 112.

In some arrangements, the transaction analysis circuit 154 may also search image of the received piece of user mail for various common characteristics of past fraudulent mail-based transactions. For example, fraudulent schemes may offer rewards (e.g., a free product, vacation, and the like) to the user 110 in exchange for the user 110 providing sensitive information. Accordingly, the transaction analysis circuit 154 may run a keyword analysis search of the image of the received user mail for instances of any phrases commonly found in various fraudulent schemes. A similar analysis may be performed for various other aspects of fraudulent mailing schemes (e.g., particular logos, particular product prices, particular instructions to the user 110, and the like).

It is determined if any of the additional fraud checks revealed any additional fraud indicators at 314. If the processes discussed above revealed inconsistencies between the received piece of user mail 112 and past legitimate transactions, or other common characteristics of fraudulent mail are found, the transaction analysis circuit 154 may identify the mail as fraudulent and perform the steps 308-310 discussed above.

If, however, none of the above mentioned fraud indicators were found, the transaction analysis circuit 154 may transmit a legitimacy indication to the mail analysis device 130 at 316. The legitimacy indication may indicate to the mail analysis device 130 that the transaction proposed by the received piece of user mail is legitimate. As such, the received piece of user mail 112 may be sorted in accordance with various preferences set by the user 110 via the various processes discussed above.

The user is notified of the proposed legitimate transaction at 318. In some embodiments, the transaction analysis circuit 154 generates a transaction notification for transmittal to the mail analysis device and/or user computing device 114. In various embodiments, the notification may take a similar form as the notification discussed above in relation to step 310. However, the notification of the transaction may further enable the user 110 to view and complete the proposed transaction. For example, the notification may link to the mail analysis client application 120 such that, upon the user 110 interacting with the notification, the user may be presented with the scanned image of the received piece of user mail 112. In one embodiment, upon the user 110 interacting with the notification, a signal is communicated to the mail analysis device 130 causing the mail analysis device 130 to transmit the scanned image of the piece of user mail 112 to the user computing device 114. Alternatively, the image may be transmitted to the user computing device 114 by the financial institution computing system 150. Thus, the user 110 is able to review the proposed transaction.

Further, the mail analysis client application 120 on the user computing device 114 may enable the user 110 to indicate a preference to engage in the proposed transaction. For example the user 110 may select an “order” button or the like and provide an input to the financial institution computing system 150 to complete the transaction proposed by the user mail 112. Such an input may also include a user selection of a product that they wish to purchase (e.g., if the user mail 112 provides multiple options).

Upon the user 110 providing such an input to the user computing device 114, a signal containing the input is transmitted by the user computing device 114 and received by the financial institution computing system 150 at 324. Upon the receipt of a user preference to engage in the transaction, the transaction analysis circuit 154 may perform a sequence to complete the proposed transaction on behalf of the user 110 at 326. For example, if the received piece of user mail 112 includes an order form, the transaction analysis circuit 154 may perform analysis on the scanned image to ascertain the information being requested from the user 110 to complete the proposed transaction. The required information may be retrieved from the user database 156 and used to populate various fields in the order form. A completed order form may be printed and mailed to the return address by financial institution personnel.

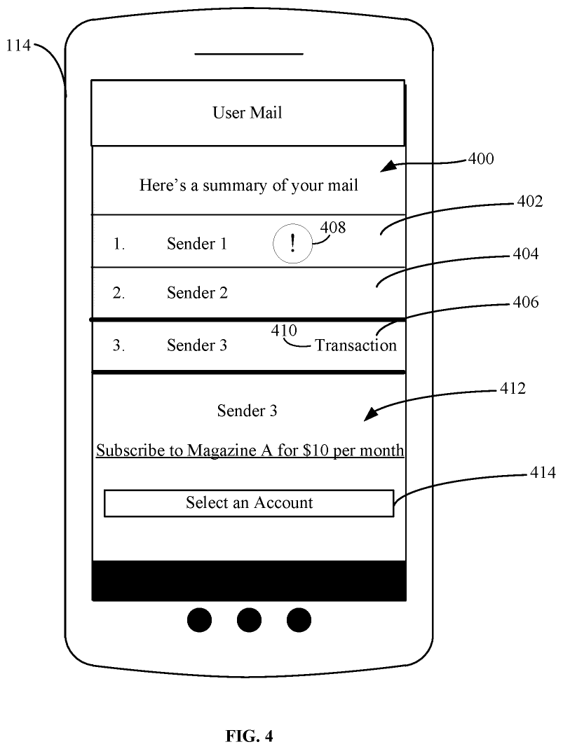

Referring now to FIG. 4, an example user interface 400 is shown, according to an example embodiment. While the interface 400 is shown to be presented to the user 110 via the user computing device 114, it should be understood that a similar interface may also be presented to the user 110 via the mail analysis device 130 (e.g., via the mail analysis I/O device 146). The interface 400 may be presented to the user during or after the mail analysis device 130 completes the method 200 discussed above. For example, the mail analysis device 130 (e.g., via the mail processing circuit 138) may transmit a dataset to the user computing device 114 (or to an external application server that provides the mail analysis client application 120 on the user device 114) that is configured to render the interface 400 on the user computing device 114 via the mail analysis client application 120.

In the example shown, the interface 400 includes a first mail entry 402, a second mail entry 404, and a third mail entry 406. Each of the mail entries 402-406 may describe a separate piece of user mail 112 that was processed by the mail analysis device 130 in accordance with the methods described herein. Each of the mail entries 402-406 identifies the sender of the piece of user mail 112. In various embodiments, each entry 402-406 may include additional information. For example, each entry may include an estimated subject of the user mail 212 as determined by the mail processing circuit 138 via the methods discussed above. The first mail entry includes a fraudulent indication 408. The fraudulent indication 408 notifies the user that either the financial institution computing system 150 (e.g., via performance of the method 300 discussed above) or the mail analysis device 130 identified at least one fraud indicator in that particular piece of user mail 112. For example, the sender in the first entry 402 may have been identified as a fraudster in the transaction database 158. As such, the user 110 is notified that the piece of user mail 112 corresponding to the user entry is fraudulent.

In some embodiments, each mail entry 402-406 also includes a mail sorting option (not shown). For example, the mail sorting option may include a dropdown menu that enables the user 110 to select a destination for the corresponding piece of user mail 112. To illustrate, the mail sorting option may include a high priority option, a low priority option, and a shredding option. If the user selects the high priority option, for example, the mail analysis device 130 may direct that piece of user mail 112 to a high priority slot of the mail dispensing device 140. If the user selects the shredding option, that piece of user mail 112 may be directed to the shredder 144. As such, the user 110 may control the placement of the user mail 112 in real time.

The third mail entry 408 includes a transaction indication 410 notifying the user 110 that the corresponding piece of user mail 112 proposes a paper-mail based transaction to the user 110. In various embodiments, the user 110 may select one of the entries 402-406 to reveal more information regarding the piece of user mail 112 gathered by the mail processing circuit 138. As indicated by the emboldened boundaries of the third mail entry 406, the user 110 has selected that entry. In response, program logic of the mail analysis application 120 updates the interface 400 to include an entry-specific window 412 that provides more details concerning the corresponding piece of user mail 112. In the example shown, the entry-specific window 412 includes a snippet of the piece of user mail 112 that proposes a transaction to the user 110.

The entry-specific window 412 further includes an account selection button 414. Upon the user selecting the account selection button 414, the user 110 may be brought to an additional interface enabling the user 110 to select an account at the financial institution to perform the transaction. In response to the user 110 selecting an account, a notification signal is relayed to the financial institution computing system 150. In turn, the financial institution computing system 150 (e.g., via the transaction analysis circuit 154) takes steps to perform the identified transaction on behalf of the user 110. For example, the transaction analysis circuit 154 may retrieve information from the user database 156 and use the retrieved information to pre-populate an order form. The order form may then be printed out and mailed by financial institution personnel on behalf of the customer 110.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit. ” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A mail analysis system, comprising:
a network interface configured to communicate data over a network;
a mail receiving device structured to receive a piece of mail associated with a user and direct the piece of mail to an imaging area;
a scanning device structured to capture a scanned image of the piece of mail in the imaging area;
a mail sorting device structured to contact the piece of user mail to send the mail in one of a predetermined number of directions;
a processing circuit comprising a processor and a memory, the memory structured to store instructions that are executable by the processor to cause the processing circuit to:
receive the scanned image captured by the scanning device;
determine if the piece of mail proposes a transaction to the user;
transmit, by the network interface, information pertaining to the transaction to a financial institution computing system associated with a financial institution responsive to determining that the piece of mail proposes a transaction to the user;
receive, by the network interface, an indication of the legitimacy of the proposed transaction from the financial institution computing system, the indication of legitimacy identifying the proposed transaction as fraudulent; and
transmit a control signal to the mail sorting device based on the legitimacy of the proposed transaction.

2. The system of claim 1, further comprising a mail shredding device configured to receive and shred the received piece of user mail, wherein, upon receiving the indication of the legitimacy identifying the proposed transaction as fraudulent, the control signal configures the mail sorting device to send the piece of mail in a mail shredding direction to the mail shredding device.

3. (canceled)

4. (canceled)

5. The system of claim 1, wherein the instructions further cause the processing circuit to determine a characteristic of the received piece of user mail based on the scanned image, and the determining of the characteristic includes determining if the received piece of mail is received from a sender identified by a user preference stored in a user database.

6. The system of claim 1, wherein the instructions further cause the processing circuit to determine a characteristic of the received piece of user mail based on the scanned image, and the determining of the characteristic includes:
performing a textual analysis on the text included on the received piece of mail to determine a subject of the received piece of mail; and
determining a category for the received piece of user mail based on the determined subject.

7. The system of claim 6, wherein the instructions further cause the processing circuit to transmit a notification describing the received piece of user mail to a user computing device associated with the user, the notification including at least one of the legitimacy indication and the determined category for the received piece of user mail.

8-20. (canceled)

21. A method comprising:
receiving, by a processing circuit, a scanned image of a piece of mail in an imaging area captured by a scanning device;
determining, by the processing circuit, that the piece of mail proposes a transaction to a user;
transmitting, by a network interface, information pertaining to the transaction to a financial institution computing system associated with a financial institution responsive to determining that the piece of mail proposes the transaction to the user;
receiving, by the network interface, an indication of the legitimacy of the proposed transaction from the financial institution computing system, the indication of legitimacy identifying the proposed transaction as fraudulent;
transmitting a control signal to a mail sorting device based on the legitimacy of the proposed transaction; and
sending, by the mail sorting device, the piece of mail in one of a predetermined number of directions based on the control signal.

22. The method of claim 21, further comprising receiving and shredding, by a mail shredding device, the piece of mail, wherein, upon receipt of the indication of the legitimacy identifying the transaction as fraudulent, the control signal configures the mail sorting device to send the piece of mail in a mail shredding direction to a mail shredding device.

23. The method of claim 21, further comprising determining, by the processing circuit, if the received piece of mail is received from a sender identified by a user preference stored in a user database.

24. The method of claim 21, further comprising:
performing, by the processing circuit, a textual analysis on the text included on the received piece of mail to determine a subject of the received piece of mail; and
determining, by the processing circuit, a category for the received piece of user mail based on the determined subject.

25. The method of claim 24, further comprising transmitting, by the processing circuit, a notification describing the received piece of user mail to a user computing device associated with the user, the notification including at least one of the legitimacy indication and the determined category for the received piece of user mail.

26. (canceled)
